(19) United States
(12) Patent Application Publication
(10) Pub. No.: US 2009/0121098 A1
(43) Pub. Date: May 14, 2009

(54) STAND AND DISPLAY DEVICE HAVING THE SAME

(75) Inventors: Hui-Ling Chao, Hsin-Chu (TW); Min-Hao Yuan, Hsin-Chu (TW); Ching-Tang Chang, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Coretronics Corporation, Hsin-Chu (TW)

(21) Appl. No.: 12/114,835

(22) Filed: May 5, 2008

(30) Foreign Application Priority Data
Nov. 9, 2007 (TW) 96142489

(51) Int. Cl. F16M 11/00

(52) U.S. Cl. 248/161

(57) ABSTRACT

A stand for supporting a display screen of a display device is provided. The stand includes a base plate, a height adjusting mechanism, and a sleeve. One end of the height adjusting mechanism is connected to the base plate, and the other end of the height adjusting mechanism is connected to the display screen. The sleeve surrounds the height adjusting mechanism. One end of the sleeve is connected to the one end of the height adjusting mechanism, and the other end of the sleeve is connected to the other end of the height adjusting mechanism. The sleeve has a plurality of annular tooth sections connected in sequence, and the annular tooth sections may be extended or compressed according to a length variation of the height adjusting mechanism.

### CROSS-REFERENCE TO RELATED APPLICATION

This application claims the priority benefit of Taiwan application serial no. 96142489, filed on Nov. 9, 2007. The entirety of the above-mentioned patent application is hereby incorporated by reference herein and made a part of specification.

### BACKGROUND OF THE INVENTION

1. Field of the Invention

The present invention relates to a stand and a display device having the same.

2. Description of Related Art

With the maturity of liquid crystal display (LCD) technology, LCD screens have gradually replaced conventional cathode ray tubes (CRT) to be used as computer screens. In order to support and erect the LCD screens on a platform, stands are utilized to achieve such function in prior art. In addition to supporting the LCD screens, the stands may also be designed to have height adjusting mechanisms for adjusting the height of the LCD screen relative to the platform. Furthermore, the stand may be designed to have a rotation mechanism for adjusting a vertical tilt angle and horizontal title angle of the LCD screen relative to the platform.

### SUMMARY OF THE INVENTION

Accordingly, the present invention is directed to a stand for supporting a display screen of a display device.

The present invention is directed to a display device having a height adjustable stand for supporting a display screen.

In one embodiment of the present invention, a stand for supporting a display screen of a display device is provided. The stand has a base plate, a height adjusting mechanism, and a sleeve. One end of the height adjusting mechanism is connected to the base plate, and the other end of the height adjusting mechanism is connected to the display screen. The sleeve surrounds the height adjusting mechanism. One end of the sleeve is connected to the one end of the height adjusting mechanism, and the other end of the sleeve is connected to the other end of the height adjusting mechanism. The sleeve has a plurality of annular tooth sections connected in sequence, and the annular tooth sections may be extended or compressed according to a length variation of the height adjusting mechanism.

In another embodiment of the present invention, a display device having a display screen and a stand is provided. The stand has a base plate, a height adjusting mechanism, and a sleeve. One end of the height adjusting mechanism is connected to the base plate, and the other end of the height adjusting mechanism is connected to the display screen. The sleeve surrounds the height adjusting mechanism. One end of the sleeve is connected to the one end of the height adjusting mechanism, and the other end of the sleeve is connected to the other end of the height adjusting mechanism. The sleeve has a plurality of annular tooth sections connected in sequence, and the annular tooth sections may be extended or compressed according to a length variation of the height adjusting mechanism.

Accordingly, in the mentioned embodiments of the invention, the sleeve formed by the plurality of annular tooth sections connected in sequence surrounds the height adjusting mechanism, so as to shield the height adjusting mechanism from sight. Furthermore, the annular tooth sections may be extended or compressed according to a length variation of the height adjusting mechanism individually, thus correspondingly changing the overall length of the sleeve.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of a display device having a stand according to an embodiment of the present invention.

FIG. 1B is a perspective view of the stand in FIG. 1A after the height is adjusted.

FIGS. 2 and 3 are exploded views of the stand in FIG. 1A from two different angles of view respectively.

### DETAILED DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

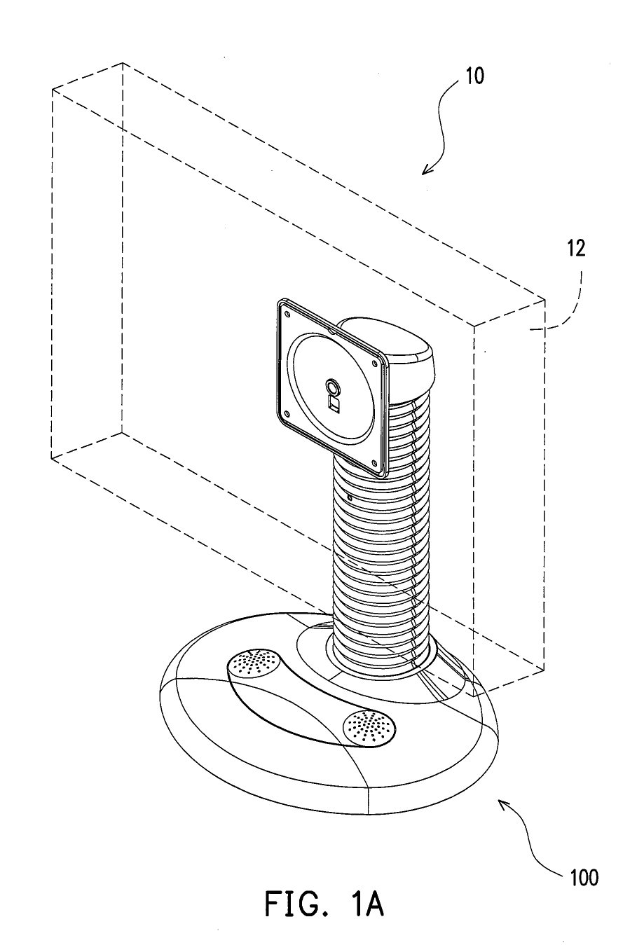

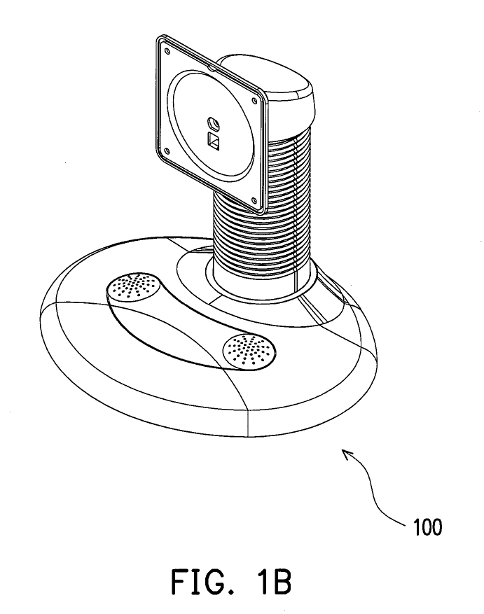

FIG. 1A is a perspective view of a display device having a stand according to an embodiment of the present invention, and FIG. 1B is a perspective view of the stand in FIG. 1A after the height is adjusted. Referring to FIGS. 1A and 1B, a display device 10 of this embodiment has a display screen 12 and a stand 100. The stand 100 is connected to the display screen 12 to support the display screen 12, so as to erect the display screen 12 on a platform (not shown), and is capable of adjusting the height of the display screen 12 relative to the platform. In this embodiment, the display screen 12 is a liquid crystal display screen.

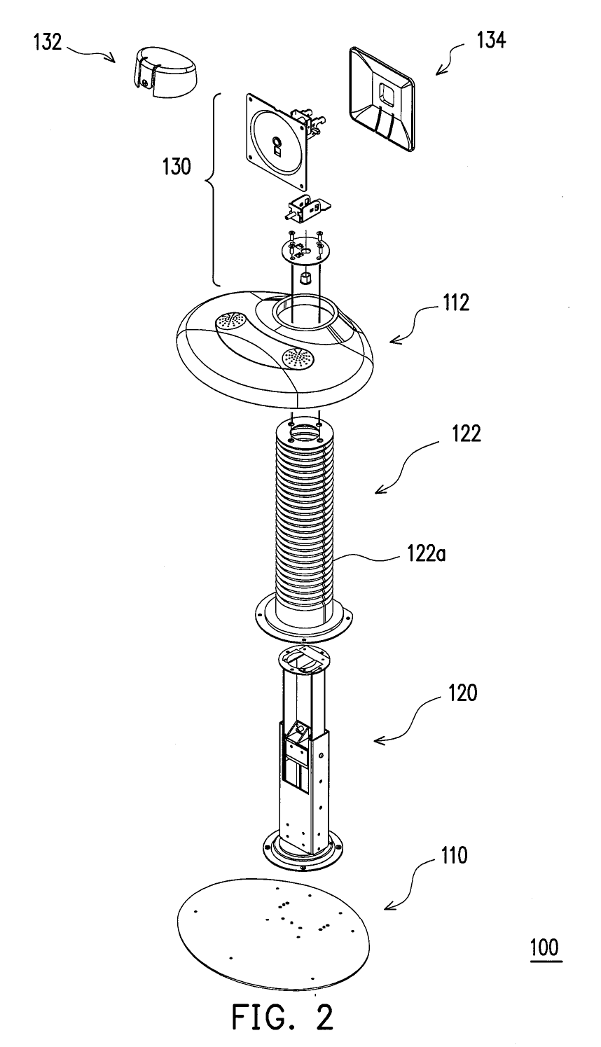

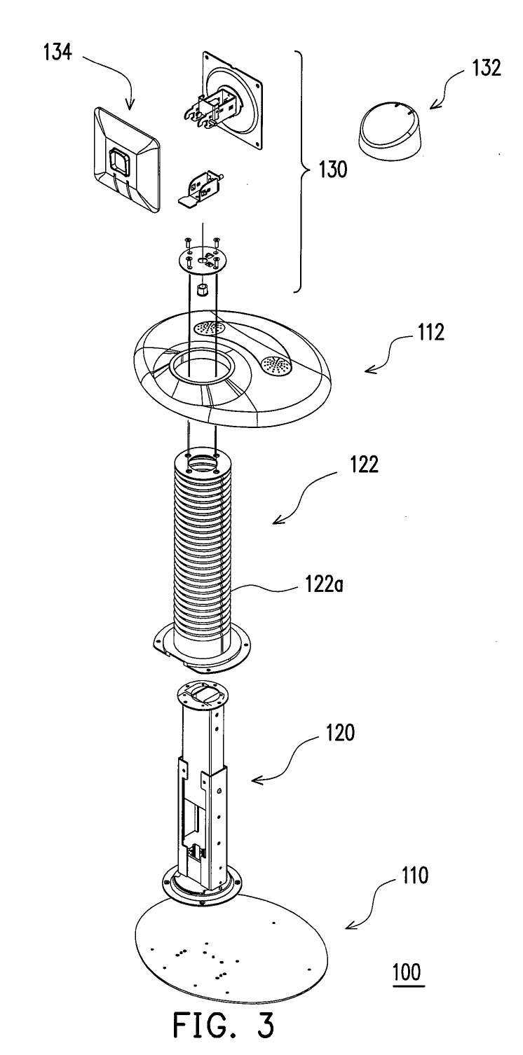

FIGS. 2 and 3 are exploded views of the stand in FIG. 1A from two different angles of view respectively. Referring to FIGS. 2 and 3, a stand 100 includes a base plate 110, a height adjusting mechanism 120, and a sleeve 122. In this embodiment, the base plate 110 is a metal piece. Furthermore, one end of the height adjusting mechanism 120 is connected to the base plate 110, and the other end of the height adjusting mechanism 120 is connected to the display screen 12.

It is notable that the height adjusting mechanism 120 has a semi-automatic positioning function. That is, the user may manually adjust a length of the height adjusting mechanism 120 to fix the display screen 12 at a desired height. In this embodiment, the height adjusting mechanism 120 is a type of constant force spring. In other embodiments, the height adjusting mechanism 120 may be a type of air cylinder or a type of compression spring.

The sleeve 122 surrounds the height adjusting mechanism 120. Two ends of the sleeve 122 are connected to the two ends of the height adjusting mechanism 120 respectively, so as to shield the height adjusting mechanism 120 from sight. The sleeve 122 has a plurality of annular tooth sections 122a connected in sequence, and the annular tooth sections 122a may be extended (as shown in FIG. 1A) or compressed (as shown in FIG. 1B) according to the length variation of the height adjusting mechanism 120 individually, thus changing the overall length of the sleeve 122. In this embodiment, the sleeve 122 is an elastic plastic piece.

In addition to adjusting height, in this embodiment, the stand 100 further has a rotation mechanism 130 connected between the back of the display screen 12 and the upper end of the height adjusting mechanism 120. In this embodiment, the rotation mechanism 130 has three degrees of rotational freedom, so as to adjust the vertical tilt angle and the horizontal title angle of the display screen 12 relative to the platform, and rotate the display screen 12 about the facing direction of the display screen 12 relative to the platform.

Similarly, in order to meet appearance requirements, the stand 100 further has a base cover 112 encompassing the upper half portion of the base plate 110. Furthermore, the stand 100 further has an outer cover 132 encompassing a portion of the rotation mechanism 130. Furthermore, the stand 100 further has an outer cover 134 encompassing the other portion of the rotation mechanism 130. In this embodiment, the base cover 112, the outer cover 132, and the outer cover 134 are plastic pieces.

In view of the above, in the embodiments of the invention, the sleeve formed by the plurality of annular tooth sections connected in sequence surrounds the height adjusting mechanism, so as to shield the height adjusting mechanism from sight. Furthermore, the annular tooth sections may be extended or compressed according to the length variation of the height adjusting mechanism individually, thus correspondingly changing the overall length of the sleeve. Furthermore, the sleeve may be formed by a single means, thus reducing the cost of the pieces required for surrounding the height adjusting mechanism.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A stand, for supporting a display screen of a display device, comprising:
a base plate;
a height adjusting mechanism, comprising one end connected to the base plate and the other end connected to the display screen; and
a sleeve, surrounding the height adjusting mechanism, comprising one end connected to the one end of the height adjusting mechanism and the other end connected to the other end of the height adjusting mechanism, and comprising a plurality of annular tooth sections connected in sequence and capable of being extended or compressed according to a length variation of the height adjusting mechanism.

2. The stand as claimed in claim 1, further comprising:
a base cover, encompassing an upper half portion of the base plate.

3. The stand as claimed in claim 1, further comprising:
a rotation mechanism, connected between the display screen and the other end of the height adjusting mechanism.

4. The stand as claimed in claim 3, further comprising:
an outer cover, encompassing a portion of the rotation mechanism.

5. The stand as claimed in claim 3, further comprising:
another outer cover, encompassing the other portion of the rotation mechanism.

6. A display device, comprising:
a display screen; and
a stand, comprising:
a base plate;
a height adjusting mechanism, comprising one end connected to the base plate and the other end connected to the display screen; and
a sleeve, surrounding the height adjusting mechanism, comprising one end connected to the one end of the height adjusting mechanism and the other end connected to the other end of the height adjusting mechanism, and comprising a plurality of annular tooth sections connected in sequence and capable of being extended or compressed according to a length variation of the height adjusting mechanism.

7. The display screen as claimed in claim 6, wherein the stand further comprises:
a base cover, encompassing an upper half portion of the base plate.

8. The display screen as claimed in claim 6, wherein the stand further comprises:
a rotation mechanism, connected between the display screen and the other end of the height adjusting mechanism.

9. The display screen as claimed in claim 8, wherein the stand further comprises:
an outer cover, encompassing a portion of the rotation mechanism.

10. The display screen as claimed in claim 8, wherein the stand further comprises:
another outer cover, encompassing the other portion of the rotation mechanism.
